(19) United States
(12) Patent Application Publication
(10) Pub. No.: US 2013/0292435 A1
(43) Pub. Date: Nov. 7, 2013

(54) Tissue box holder mountable on the console box of a vehicle

(71) Applicant: Yong Zhang, Canton, MI (US)

(72) Inventor: Yong Zhang, Canton, MI (US)

(21) Appl. No.: 13/462,963

(22) Filed: May 3, 2012

(51) Int. Cl. B60R 7/04

(52) U.S. Cl. 224/277

(57) ABSTRACT

A tissue box holder mountable on the console box of a vehicle, comprised of a frame and an elastic band, is capable of holding a standard square tissue box securely on the top of a vehicle console box with the use of an elastic band. The console box will open and close freely. People in both front and back seats can easily access the tissue box. To replace the empty tissue box, one can simply slide out the used tissue box and slide in a new standard tissue box into the frame. No refill is required.

### BACKGROUND OF THE INVENTION

The current tissue box for a vehicle in the market is either tied on the sun shade visor or hung in the back of the seat. When tied on a sun shade visor, the tissue box disrupts the operation of the sun shade visor. The passengers in the back seat do not have direct access to the tissue box. When hung in the back of a seat, the people in the front seats do not have access to the tissue box. Also, many of these devices require non-standard tissue boxes and refills.

The tissue box holder mountable on the console box of a vehicle invented here can hold a standard square tissue box like from the Kleenex brand firmly on the top of a console box lid. The console box is located in the middle of a vehicle; therefore the tissue box is accessible to all passengers in both front and back seats. It does not disrupt the operation of a console box or cause any damage to the console box. More importantly, it does not need refill. Once the tissue box is empty, one simply slide out the used tissue box and slide a new tissue box into the tissue box holder.

### BRIEF SUMMARY OF THE INVENTION

1. The present invention relates to a tissue box holder mountable on the console box of a vehicle which is comprised of a frame and an elastic band attached to the base of the frame. The frame is composed of a planar base, a sidewall attached to the base, two side arms parallel and above the base and two slots formed between the side arms and the base.

2. The planar base, sidewall and side arms may be made of different shapes and sizes.

3. The tissue box holder mountable on the console box of a vehicle has three different models due to the different shapes of the planar base. However, they all share the same effects and functionalities.

4. The present invention uses the planar base, sidewall, side arms and slots to create a unique mechanism of holding a tissue box securely in the tissue box holder which is then fastened to a console box located in the middle of a vehicle.

5. The invention provides a simple solution for all people in both front and back seats to conveniently access the tissue box without deforming or damaging the tissue box, console box, or disrupting the operation of the console box.

6. The present invention also allows people to use standard tissue boxes like those from the Kleenex brand, and does not require people to purchase any special refill or tissue box.

7. The tissue box holder may need, but not limited to, an elastic band to tie it onto the surface of a console box lid. The elastic band is recommended for use in the present invention because its elasticity does not inhibit the closing of a console box lid.

### BRIEF DESCRIPTION OF THE DRAWINGS

Picture Embodiments of the present invention are discussed in detail below. The measurements displayed are in inch.

FIG. 1 is a perspective view of a tissue box holder with a tissue box seating on it mounted on the surface of a console box through an elastic band.

FIG. 2 is a perspective view similar to FIG. 1 without a tissue box showing the tissue box holder being fastened on the top of a console box lid with an elastic band.

FIG. 3 is an enlarged view depicting the assembly details of a tissue box holder and a tissue box.

FIG. 4 is a perspective view of the first model of the present invention.

FIG. 5 is a perspective view of the second model of the present invention.

FIG. 6 is a perspective view of the third model of the present invention.

FIG. 7 is a sectional view of a side arm displaying the different types of side arm of the prevent invention.

### DETAILED DESCRIPTION OF THE INVENTION

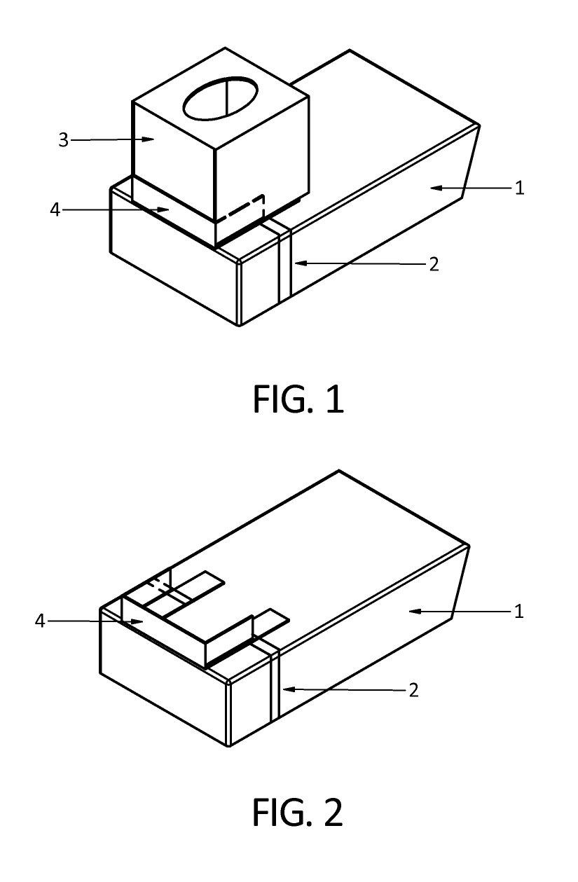

A tissue box holder mountable on the console box of a vehicle is capable of holding a standard square tissue box from brands such as Kleenex or Kirkland securely in the tissue box holder. The holder is then fastened on the top of a console box lid in most types of vehicles as seen in FIG. 1 and FIG. 2. The tissue box holder is comprised of a frame 4 and an elastic band 2. The frame includes a planar base 5, a sidewall 6 attached to the base, two side arms 7 vertical to the base and two slots 8 formed between the side arms and the base as shown in FIGS. 4-6.

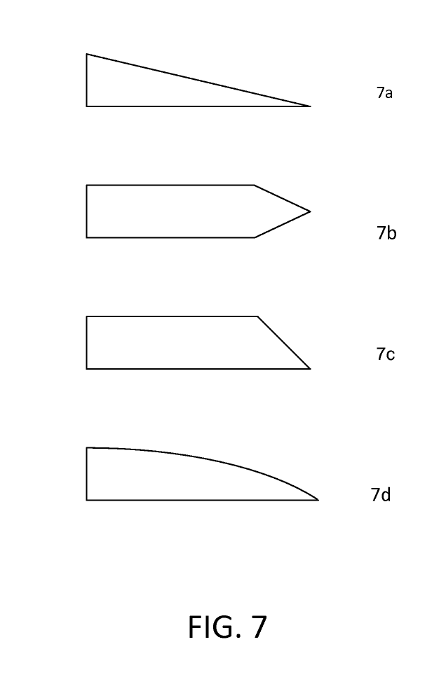

To avoid confusion, the side with a sidewall is defined as the length of a tissue box holder, and the side vertical to the sidewall as the width. Referring to the FIGS. 4-6, the planar base 5 provides a support for the upstanding sidewall 6. The planar base may have, but is not limited to, the three shapes. Other modifications may be derived from these basic shapes. For example, the planar base may have one wide slot in the middle intruding into the planar base from a side which is just a modification of the first model. Although the planar base may be square or rectangular, a length longer than a standard tissue box is not practical. The sidewall is attached to the base. The optimal shape of a sidewall should be rectangular with its height less than its length. The sidewall should have the same length as a standard square tissue box or same width as a rectangular tissue box. The base may or may not have same length as the sidewall as long as the base can effectively support the sidewall. The two side arms 7 vertical to the planar base originate and protrude from the two short sides of the sidewall in the same direction as the planar base. The shape of a side arm may be a triangle 7a, pentagon 7b, trapezoid 7c or arc 7d as seen in FIG. 7 besides rectangle as displayed in FIGS. 4-6. However, it is most desirable to make the lower edge straight since one of its roles is to hold down the bottom of a tissue box and prevent it from being pulled up. In general, the length of a side arm should not exceed the length of a tissue box; in fact, one half of the length of a tissue box or less is sufficient enough to function well. Between the two parallel side arms and the base are two slots 8. The elastic band slides through the slots and tie the tissue box holder onto the top of a console box lid. The slots need to be wide or large enough to let the bottom of a tissue box and elastic band to slide in.

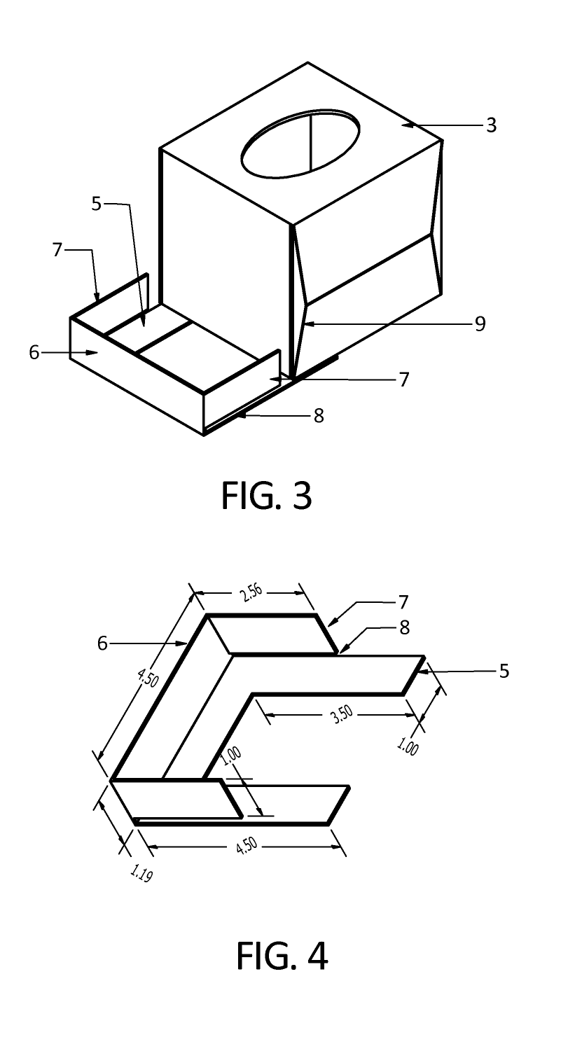

In summary, the unique design of the present invention creates a unique mechanism to effectively hold a tissue box in the box holder. The sidewall 6 prevents the tissue box 3 from slipping off the box holder when the console box 1 is open. The two parallel side arms 7 slide into the two crevices 9 between the folds of a tissue box, gripping firmly the tissue box in the holder. The two slots 8 between the two side arms 7 and the base 5 allow the bottom of a tissue box to slide in to prevent the tissue box from being pulled up as shown in FIG. 3. The sidewall, side arms and slots work together to hold a tissue box firmly in the tissue box holder.

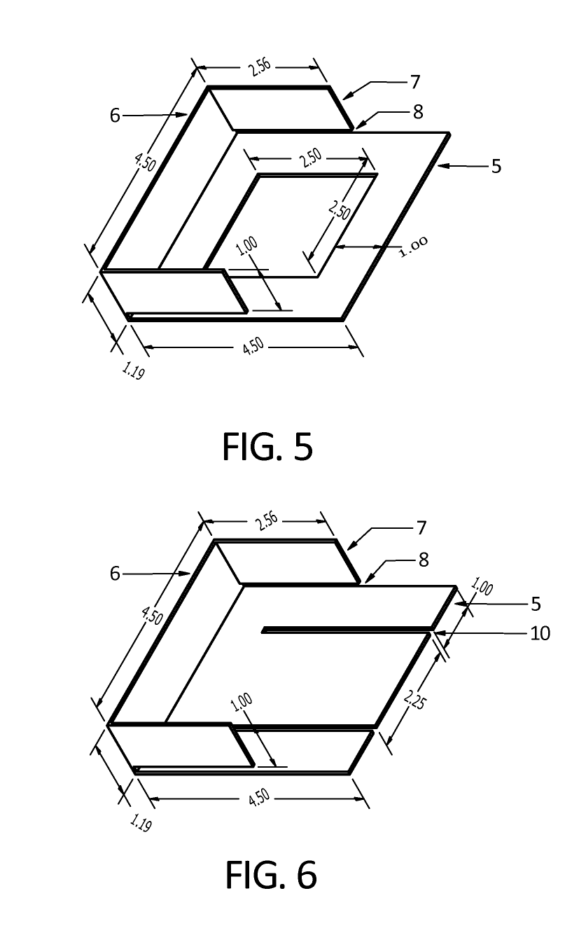

The tissue box holder mountable on the console box of a vehicle has three different models, as reflected by the three different planer bases. The first model has a concave planar base as shown in FIG. 4. The second model has a planar base that has a set of two concentric squares; the area that the inner square occupies is removed as seen in FIG. 5. The third model has a planar base that has two slots 10 intruding into the planar base from a side as displayed in FIG. 6. The differences of these planar bases do not change or limit their effects by any means. Instead, they all share the same functionalities which are to provide a support for the sidewall to attach and to form the slots for an elastic band 2 to fasten as seen in FIG. 2. Therefore, the differences of these models are more of concern of production process and cost than their functionality.

The tissue box holder needs to be fastened on the lid of a console box and the elastic band 2 is the preferred material to use as seen in FIG. 1 and FIG. 2. This is because the elasticity of a rubber strip will not inhibit the closing of a console lid, especially for the case where a user wants to fasten the elastic band between the upper lid and inner lid of a console box. The elastic band can be adjusted to fit the different types of console boxes with the use of a buckle or similar means.

The described and illustrated above herein are the preferred embodiments of a tissue box holder mountable on the console box of a vehicle. Although particular embodiments of the invention have been described above, it is not intended that the invention be limited thereto. It is intended that the invention would be as broad in scope as the specification be read likewise. For example, although the box holder is specifically designed to hold square tissue box, it can be easily adapted and configured to hold differently shaped tissue boxes like the rectangular box. The actual measurements, shapes or sizes may be modified to meet the different standards of production. In addition, although the means for fastening preferably comprise of elastic bands, other fastening means may be employed. For example, some types of vehicle console boxes have a smooth plastic surface which allows a double-sided glue tape be applied on the planar base and stick the frame on the surface of a console box.

1. A tissue box holder comprising: a frame mountable on the console box of a vehicle having a planar base and an upstanding sidewall attached to the base; two side arms vertical to the planar base originating from both ends of the sidewall and extending in the direction of the base; and two slots formed between the two side arms and the planar base.

2. The tissue box holder of claim 1 may need preferably, but not limited to, an elastic band to fasten it to the top of a console box lid.

3. The tissue box holder of claim 1 is made of plastic or metal.

4. The tissue box holder of claim 1 has a square or rectangular planar base.

5. The tissue box holder of claim 1 has an upstanding sidewall shaped like a rectangle attached to the planar base. The sidewall has the same length as a square tissue box and may have differing heights.

6. The tissue box holder of claims 1 has two parallel side arms vertical to the planar base originating at both ends of a sidewall and extending in the direction of the planar base. The shape of a side arm may be a triangle, pentagon, trapezoid or arc.

7. The tissue box holder of claim 1 has two parallel slots formed between the two side arms and the planar base.

8. The tissue box holder according to claim 1, claim 3, claim 4, claim 5 and claim 6 creates a unique and effective mechanism to hold a tissue box securely in the box holder with the unique design utilizing sidewalls, side arms and slots.

9. The tissue box holder of claim 1 has three different models due to the different types of planar bases.

10. The first model of the tissue box holder according to claim 1 and claim 8 has a concave planar base. The central outer side of the planar base has attached to it the rectangular sidewall, and protruding from the two short sides of the sidewall are the two side arms.

11. The second model of the tissue box holder according to claim 1 and claim 8 has a planar base that has a set of two concentric squares; the area that the inner square occupies is removed. From one side of the planar base there is attached the rectangular sidewall, and protruding from the two short sides of the sidewall are the two side arms.

12. The third model of the tissue box holder according to claim 1 and claim 8 has a planar base that has two slots intruding into the planar base from a side. On the side across from the intruding slots, there is attached the rectangular sidewall, and protruding from the two short sides of the sidewall are the two side arms.

13. The tissue box holder of claim 1 has an elastic band attached to the base of a tissue box holder to fasten the box holder onto the surface of a console box lid.

14. The thickness of the tissue box holder mountable on the console box of a vehicle according to claim 1 may vary depending on the used materials.
